(19) United States
(12) Patent Application Publication
(10) Pub. No.: US 2008/0312902 A1
(43) Pub. Date: Dec. 18, 2008

(54) Interlanguage communication with verification

(76) Inventor: Russell Kenneth Dollinger, Northridge, CA (US)

Correspondence Address: Russell K. Dollinger, Unit B, Ingenuitor, 18121 parthenia St., Northridge, CA, 91325, US

(21) Appl. No.: 12/214,284

(22) Filed: Jun. 18, 2008

Related U.S. Application Data
(60) Provisional application No. 60/936,021, filed on Jun. 18, 2007.

(51) Int. Cl. G06F 17/28

(52) U.S. Cl. 704/4

(57) ABSTRACT

An apparatus, method, and control means enabling a user to select a phrase (196) from a logically ordered phrase-set (140) displayed on a user display (32), to display a translation of that phrase (196) into the target language (144) on a respondent display (44), and to play a prerecorded audio file (188) of a native speaker of that target language (144). If the phrase (196) is a question, the respondent, in turn, can select one of the limited choice answers (198) displayed on the respondent display (44). The translation of the respondent's selection, in the case of an answer to a question, is then displayed in the source language (142) on the user's display (32). A verified history of the previous questions and answers asked and answered plus an audio and video record is maintained by the system for the user to review.

### CROSS-REFERENCE TO RELATED APPLICATIONS

This application claims the benefit of provisional patent application Ser. No. 60/936,021, filed 2007 Jun. 18, entitled “A 2-Way, Personal Interlanguage Communicator,” by the present inventor.

### FEDERALLY SPONSORED RESEARCH

Not Applicable

### SEQUENCE LISTING OR PROGRAM

Not Applicable

### FIELD OF THE INVENTION

This invention relates generally to a method and apparatus for enhancing communication between two or more persons using different languages.

### BACKGROUND

Throughout recorded history people have attempted to communicate with people that speak other languages. Unfortunately, despite enormous technological advances, communication problems seem to be getting worse as the world grows smaller. People that 100 years ago had no interaction with each other are now visiting the other's country, doing business together, marrying, helping in crises, battling with each other, and even praying together. There is a greater mix of languages in everyday usage now than ever before.

### SUMMARY

While there has been progress in machine translation, speech recognition, and the development of the so-called “electronic translator,” significant communication errors are still possible that can result, in some situations, in an emergency. For example, in a medical situation, the professional's ability to conduct a thorough diagnosis and treatment of a patient is almost impossible if they cannot understand each other. It is similarly critical to have an accurate, verifiable record of who said what to whom. Most professionals in many fields will have some notes that they write for themselves, but the actual record is often not dictated or written immediately. Failures of memory due to time, overload, or fatigue can also lead to serious mistakes. An automatic verifiable record of a person-to-person interaction that can be archived for future use is becoming more and more important.

The present invention is directed to a system for communication between two or more people that do not speak the same language and more particularly to an interlanguage communication apparatus and method that enables a self-reinforcing, self-validating, and self-repairing ability to communicate information between humans.

For there to be a verifiable record of an interaction between people there must be a record of who said what to whom that can be checked for accuracy against an impartial source. In an electronic interaction there must be a record of what file was selected to be displayed, what the file was supposed to show, what file was actually displayed, and whether the file displayed correctly.

Verifying the accuracy of a communication develops some unexpected twists when dealing with interlanguage communication. For example, if one happens to view a computer screen (e.g. website) that is written in a language and code not loaded onto to the computer, everything can turn into gibberish. That is because the text is stored as single or double byte characters which are then rendered onto the screen by some script. If the wrong font, operating system, CODEC or script is loaded, the text can be rendered incorrectly. It can turn into unreadable symbols but occasionally it will alter the text only slightly. For example, the order of a set of numbers transferred from a document composed on a right-to-left operating system (e.g. Hebrew) can change in unpredictable ways on a left-to-right operating system. It thus becomes clear that it is desirable to assure that the question that a patient would see, by example, is not only readable but also matches what the doctor asked.

Therefore, to have an accurate communication, let alone history, that can be verified it is advantageous to have a way to guarantee what question the other person answered or that their response displayed correctly on the user's screen. Further, the existence of a system to record who responded is preferred, since it otherwise would be quite easy for one person to both ask and answer the questions and create a fraudulent record.

Preferred embodiments of the invention employ phrases that have been converted to graphic files. In other words, the phrases have been converted from a word or concept represented by a string of letters, characters, icons, or symbols to a picture. For example, the word “dog” is converted from a word made up of three alphabetic characters into a picture of the word “dog.” This enables the interlanguage communication system of this invention to portray any “written” language equally well without the need for special operating systems, special scripts, special fonts, or special keyboards.

In a specific preferred embodiment, the graphic files are in the PNG format; however, one knowledgeable in the art will understand that other bit-mapped file formats such as BMP, GIF, JPG, and TIF will also work. Alternative embodiments might use vector-based graphic files such as EPS or SVG.

In accordance with one aspect of the preferred embodiment, a cryptographic checksum is calculated for every graphic (phrase) that has been converted to an image file for display on any and all of the screens. In a specific preferred embodiment, the checksum algorithm that is used is the MD5; however, one knowledgeable in the art will understand that other checksum algorithms could also be used under different situations with different security requirements, such as the hash algorithms: Gost-Hash, HAS-160, MD2, RIPEMD, Tiger, etc., MAC algorithms: DAA, HMAC, VEST, and others. One knowledgeable in the art will recognize that other verification techniques in addition to checksum comparisons can be employed.

In a preferred embodiment the graphic representation of the phrases included in a relational database comprise a set of related phrases posed as questions or commands (e.g. medical) that include a plurality of variations of language, gender, and honorific level. The included phrases can be grouped by phrase identification number, language of the user, language of the respondent, thematic category, gender of the user, gender of the respondent, honorific level of the user, honorific level of the respondent, password access level of the user, and checksums for each graphic representation of a phrase in each language. Thus in this embodiment, there could be a phrase for a Japanese-speaking adult male with a high honorific level asking a Spanish-speaking boy with a low honorific level about the level of pain. Similarly there could be another phrase for the boy's response.

In a preferred embodiment of this invention the user will have the ability to choose a phrase-set from a plurality of phrase-sets. Each phrase-set is made up of a collection of phrases that is pertinent to that thematic category. For example, a medical phrase-set will cover issues such as: “Pain,” “Chest Problems,” “Obstetrics/Gynecology,” etc. while an exemplary phrase-set for law enforcement would cover: “Traffic Stops,” “Field Sobriety Test,” “Searches,” etc. Each database could theoretically be stored on a separate memory card such as is well-known in the art. Each phrase-set can either be stored in its own database or a plurality of phrase-sets can be stored in a single database.

A preferred embodiment of the relational database is made up of a plurality of phrase identification directories each with a unique identification number. Each phrase directory contains everything relevant to that phrase identification number including a respondent screen graphic for each language that will be displayed on a respondent screen, a user screen graphic for each language that will be displayed on a user screen, an audio file of that phrase recorded in each language by a native speaker that will be played through speakers, a local language equivalent of that phrase graphic in each language, and a phrase usability flag for each phrase/language combination.

Placing all the elements relating to a particular phrase within a single phrase directory enables the application to replace elements quickly without querying the database for the location of the appropriate files when a source language or target language is changed. For example if an English-speaking doctor starts an interview with a Punjabi-speaking patient followed by a Korean-speaking doctor, switching between Punjabi and Korean source languages is immediate. Each of the various elements on the user screen would be redrawn with a replacement graphic for the same phrase identification number but a different language number. There is no need for a Language Resource Manager as in some other solutions, nor is there a need to load special fonts or operating systems.

In accordance with the preferred embodiment of this invention there is provided a method and software configuration to include a local language equivalent for each phrase in the database of phrases so that the interlanguage communication system can be localized by locale and language. Thus, when the user/respondent interaction is finished and the file is uploaded to a host computer for training or transfer, the uploaded file will also include the phrases in a format that is readily accessed and printed in the local area. By example, a border patrol agent in the United States might choose English as the local language equivalent, while a physician in the Netherlands might choose Dutch.

In accordance with another aspect of the preferred embodiment of this invention there is included an apparatus, method, and software instructions configured for the creation and maintenance of user profiles with associated information regarding preferred default language, gender, phrase-set, source language, target language, date and time format, critical phrase identification numbers, and audio/video settings. The cryptographically password protected user profile allows for sensitive information, such as a patient's medical record, to be protected. In another aspect of the preferred embodiment, a method and software instructions configured to allow certain phrases to be used only by authorized users may be included. This is particularly useful, for example, in a sensitive situation, such as a rape investigation, or where particular questions are regionally prohibited by law.

In the preferred embodiment of the invention at least one relational database of phrases and associated information is stored in non-volatile memory together with executable software instructions configured to be accessed by a CPU and to show selected phrases on a display and/or to play selected phrases through a speaker.

More specifically, the apparatus and method in accordance with the invention permits a user to easily communicate between two or more persons via a 2-way audiovisual presentation that can be verified for accuracy. The apparatus includes at least a display (screen) and preferably more than one display that can be moved and/or rotated relative to each other, sound generators (e.g. loudspeakers), and the control equipment necessary to present the audiovisual material on the displays and/or sound generators. This will enable a user that speaks a particular source language to choose a particular phrase (e.g. “Are you in pain?”) from many possible phrases, to present an audio-visual presentation of the equivalent target language version of that phrase to a respondent that speaks a particular target language, and then to have the respondent select one of the answers presented in the target language. The equivalent source language version is then presented audio-visually to the user.

An alternative embodiment of this invention provides the interlanguage communicator with a rotatable, touch screen-equipped second display that can be detached and used wirelessly when the user cannot be in close proximity to the respondent or when it is a hazardous situation.

An additional alternative embodiment of this invention comprises the use of two or more computing devices that communicate wirelessly with each other, each unit further comprising at least one relational database of phrases and associated information stored in non-volatile memory together with executable software instructions configured to be accessed by a CPU and to show selected phrases on a display and/or to play selected phrases through a speaker. The two or more units can be used separately, or they can be stored together in a holder that allows them to be rotated relative to each other. When necessary one of the units can be removed and used by a user. For example, a paramedic may choose to keep and use the individual units in a package format with a patient that is unable to hold a separate unit in one incident, but may need to hand one of the units to somebody trapped in a car in another incident. The paramedic's unit would still be able to transmit wirelessly with that of the trapped person's unit thus enabling communication with the paramedic.

A preferred embodiment when there two or more units that communicate wirelessly with each other includes acknowledgments of file transfer in addition to checksum accuracy. In the preferred implementation when a unit A wants to display a message on unit B, unit A sends the phrase identification number and a position identifier that indicates where on the screen that the phrase will be displayed. Unit B loads the requisite files and sends back an acknowledgment. (The path generation algorithm which is used to determine the path to the correct file is described later.) This acknowledgment includes the phrase identification number and the position ID, for verification, as well as the language code in use by unit B and the checksum of the file that was displayed. Unit A can log this acknowledgment (so both sides have a complete copy of the transcript including checksum verification) and can compare that checksum with the one in its local copy of the database for verification. (Because the acknowledgment includes the language code, timing interactions are not a problem and the protocol can scale to 3+ units.) Acknowledgments can be sent arbitrarily, without needing a request; this would indicate that the unit changed the displayed phrase on its own accord (for instance, due to a language switch). If an acknowledgment is not verified against the local checksum, unit A can send a warning message so that unit B's log can also contain note of the discrepancy. One knowledgeable in the art will recognize that all units should be able to generate log files that are identical except for some small differences in time and date stamping of each phrase on each unit due to transmission latency.

Prior to presentation a checksum verification program calculates the checksum for the file to be loaded which is then compared against an archived reference, and is also recorded in non-volatile memory as an integral part of a user/respondent history. If the checksum does not match the archived reference an error is recorded. At this point the program can be stopped, or a checksum mismatch handling routine can be called to troubleshoot the problem, find, and then load a replacement file if one is available. When the checksum matches the archived reference, the graphic file is displayed or the audio file is played.

The checksum mismatch handling routine in a unit with a single processor and two or more screens can compare the checksums calculated for the loaded file against a previously calculated checksum stored in the database for a particular file. If there is a checksum mismatch, the system will note the error and can then resolve it by referral against a third source. That source could be a back-up checksum database that is stored separately in memory.

In a two or more unit version, the databases stored in each unit can act as the back-up reference for other units. Thus the checksum mismatch handling routine can compare two checksums (archived and freshly calculated) for each file for each unit. A two-unit set-up would allow four checksums to be compared thus allowing the unit to distinguish if the wrong file was loaded, if the file stored in one of the databases is bad, or if the archived checksum in one of the databases is incorrect. Depending on the situation, the correct solution can be resolved and the file can be presented. Logs of the checksum mismatch, checksums involved, and solution are recorded and stored in memory for multiple uses.

In the preferred embodiment the software instructions are configured in a path generation algorithm that uses the following steps to determine the file name: 1. Concatenating the phrase identification number and a slash to the common database root path (Example: /db/medical/123 for phrase #123 in the medical database); 2. Adding a language identifier to the path (Example:/db/medical/123/en for the English version of phrase 123); 3. Jumping to step 6 if the language is not gender-sensitive; 4. Adding a gender identifier for the first person to the path. (Example: “/db/medical/123/en-m” for when the first person is a man); 5. Adding a gender identifier for the second person to the path. (Example: “/db/medical/123/en-mf” for when the second person is a woman); 6. Jumping to step 9 if the language does not use multiple levels of honorifics; 7. Adding an honorific identifier for the first person to the path. (Example: “/db/medical/123/en-mf-h” for humble for if the first person uses a humble form); 8. Adding an honorific identifier for the second person to the path. (Example: “/db/medical/123/en-mf-hp” for polite for the second person should be addressed with a polite form), and 9. Adding a suffix for the type of presentation desired (Example: “/db/medical/123/en-mf-hp-A.png” for a PNG graphic type image appearing on unit A).

In the preferred embodiment a rearrangement of the order will yield the same file (i.e. “oper-mf-hp-en.png” is still the same technique). Further, by example, the algorithms created for the interaction between an English-speaking, male doctor with unit A and a Spanish-speaking, female patient with unit B would be /db/medical/123/es-mf-pp-B.png for the phrase to be shown on the woman's unit B screen and /db/medical/123/en-mf-pp-A.png for the unit A screen. The language listed is the language of the device displaying the phrase. The phrase identification number, gender combination, and honorific combination are the same for both devices; the language code varies according to the device and the suffix varies according to where the phrase is presented.

In a preferred embodiment of this invention an apparatus, method, and software instructions is included to enable an improved history file of the user/respondent interaction comprising a date and time stamp of every phrase (and checksum) asked and answered together with an accompanying video and audio record of the respondent that is tied to each phrase and response. More specifically, the software is configured to enable the user to search through the user/respondent history by date/time, phrase identification number #, and/or keyword.

In accordance with one preferred embodiment of this invention the control circuits shall have software instructions configured to search for a set of phrases or for a particular phrase from a plurality of phrases by category or keyword. Similar techniques allowing the user to search for a particular keyword by a character reference symbol, such as a letter, phonetic sound, symbol, or sets of symbols is also envisioned. An optional embodiment of this invention will provide the user with a list of likely phrases that the user may wish to present to the respondent based on the past history of the questions asked and answered.

An alternative embodiment of the search function that is not shown could use a search table with the columns “parent ID,” “child ID,” “language ID,” and a sequence number. The parent is a phrase such as a letter of the alphabet or a topic. The child is a phrase that should be displayed in the list when the parent is selected. The language ID is used to identify which language(s) the relationship is valid for; if the relationship is not sensitive to language (for instance, a topical relationship instead of an alphabetic one) the language ID is omitted. To distinguish between the various search trees, a “magic” phrase (not necessarily used in the interface) is the parent for all such keys—for instance, a magic phrase might be the parent for all letters of the alphabet, or might be the parent for all of the main topics.

A very serious and unaddressed, practical problem that also exists with a number of the electronic language assistants is that when the user looks down to make a selection on the language tool, they take their eyes off of the situation at hand and therefore lose control. For the tourist this may not be a significant problem, but it is potentially a matter of life and death for the soldier in the field that can result in underutilization of existing electronic language aids. A preferred embodiment of the interlanguage communication system of this invention are the apparatus and software instructions configured to obtain a live video display of the respondent and to further obtain a video record of the respondent that is tied to a particular phrase by including a video recording apparatus, software instructions configured for video recording, and software instructions configured to record a user/respondent history. The inclusion of a video display and recording system in the preferred embodiment still further enables the user to continue to watch the respondent and still maintain control of the situation by looking at a video projection of the respondent on the user display.

In some embodiments this invention also shall have the apparatus and software instructions configured to control the video recording frame-rate thereby enabling the user to assign faster frame-rates to particular phrases of critical import. Other less important phrases can be assigned a slower frame-rate, thus saving memory and battery power.

Further objects and advantages will become apparent from a consideration of the ensuing description and drawings.

### BRIEF DESCRIPTION OF THE DRAWINGS

### Figures

These and other features of the Subject Invention will be better understood in relation to the Detailed Description taken in conjunction with the Drawings, of which:

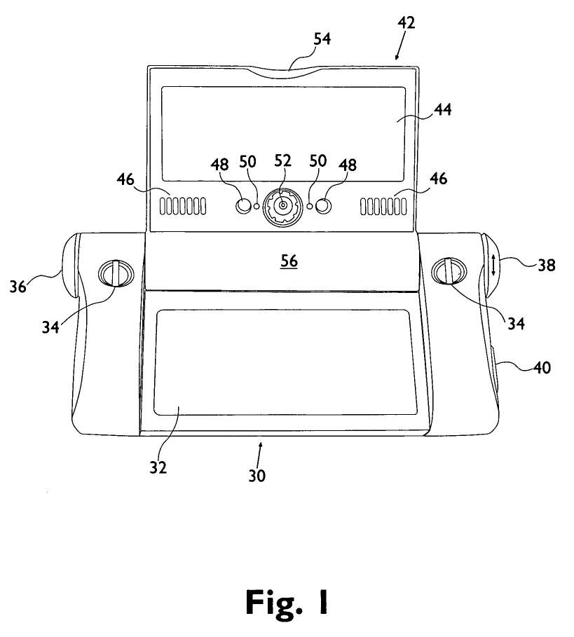

FIG. 1 is a front view of a interlanguage communicator in accordance with the preferred housing embodiment of the present invention in an opened position.

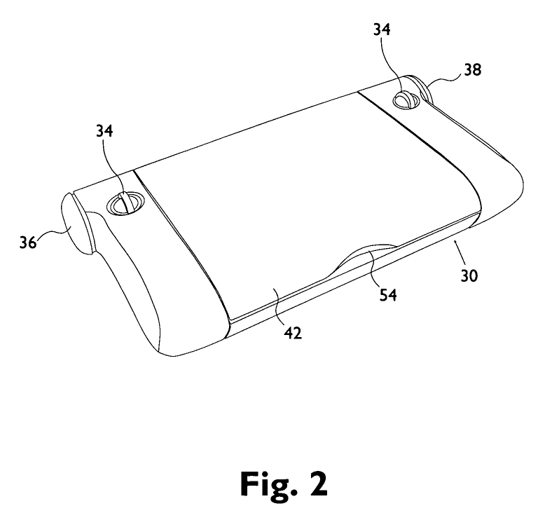

FIG. 2 is a perspective view of the device in FIG. 1 in a closed position.

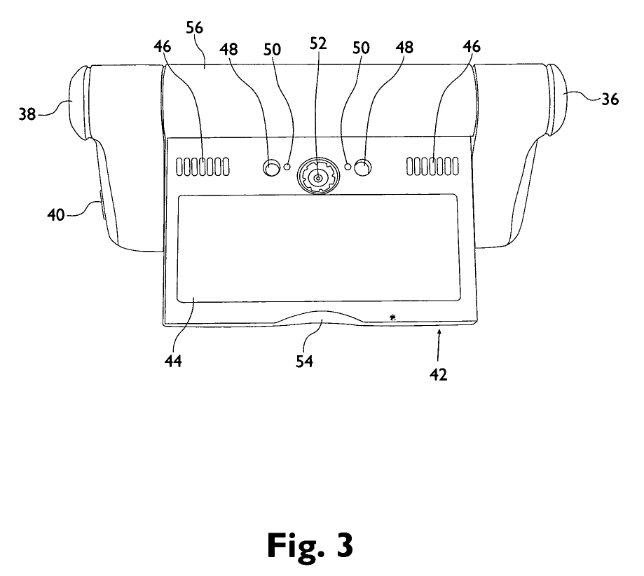

FIG. 3 is a back view of the device in FIG. 1 with the respondent side display screen rotated into an open position.

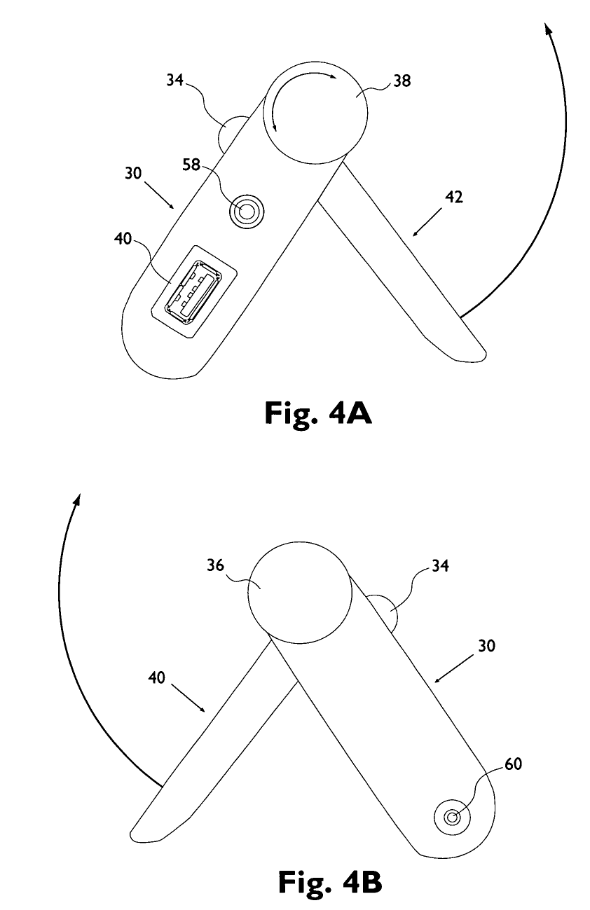

FIG. 4A is the right-side view of the device in FIG. 1 with the respondent side display screen rotated into an open position

FIG. 4B is the left-side view of the device in FIG. 1 with the respondent side display screen rotated into an open position.

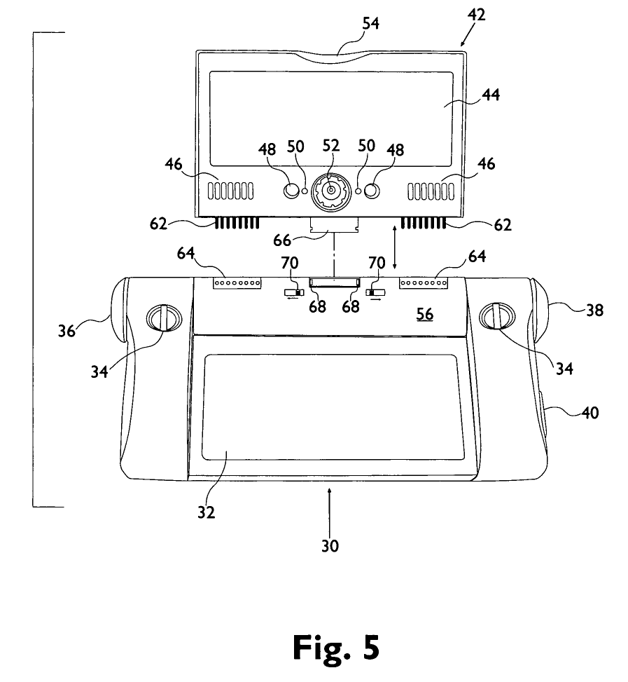

FIG. 5 is a front view of an interlanguage communicator with a rotating, detachable respondent side display screen.

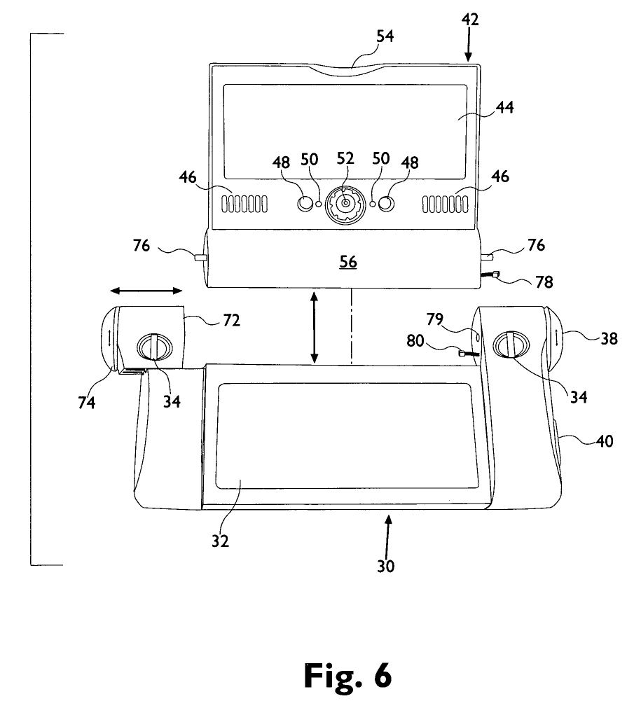

FIG. 6 is a front view of an interlanguage communicator with an alternative way to have a rotating, detachable respondent side display screen.

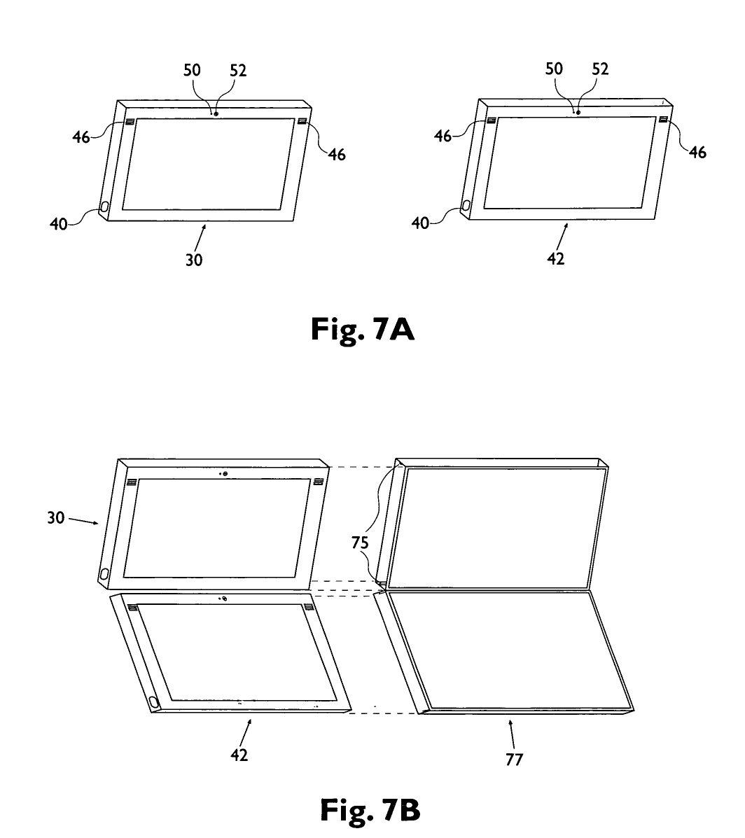

FIG. 7A is a perspective view of an alternative embodiment of an interlanguage communicator with two separate units.

FIG. 7B is a perspective view of a housing for an interlanguage communicator showing how the individual unit would slide in.

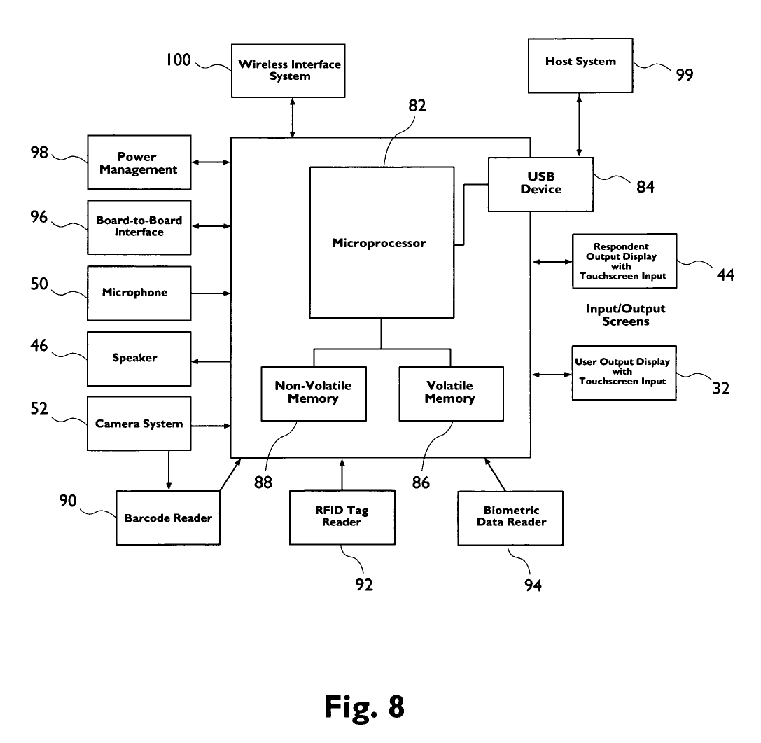

FIG. 8 is a functional block diagram of a device configured to carry out the techniques of the invention.

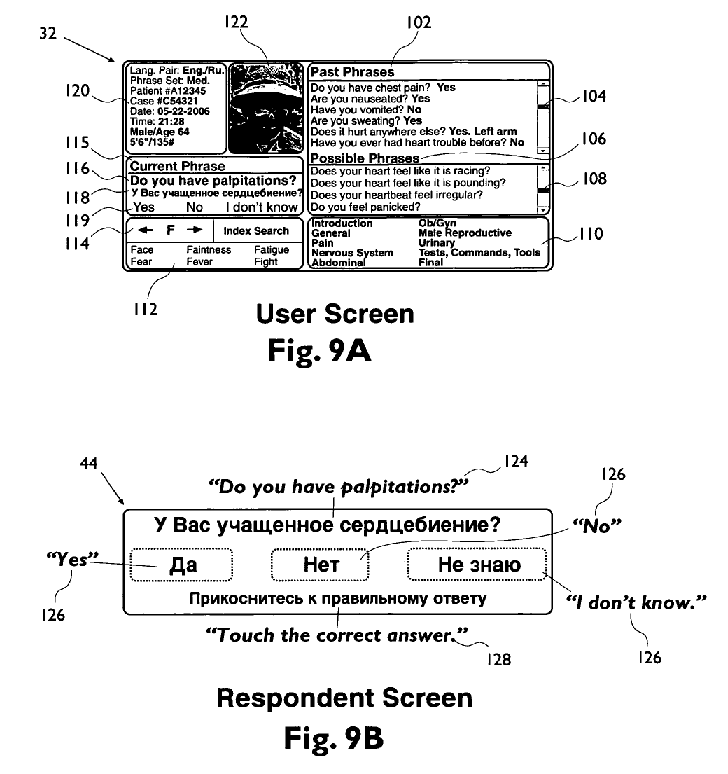

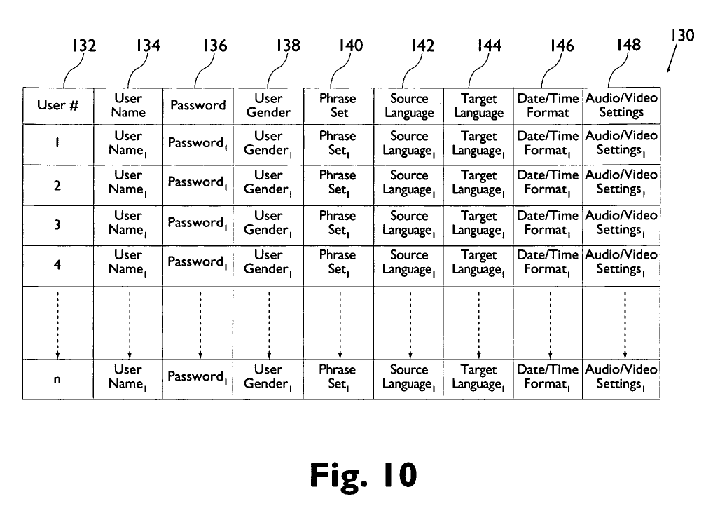

FIG. 9A is an illustration of the user display screen possible layout in the interlanguage communicator of FIG. 1.

FIG. 9B is an illustration of the respondent display screen possible layout in the interlanguage communicator of FIG. 1.

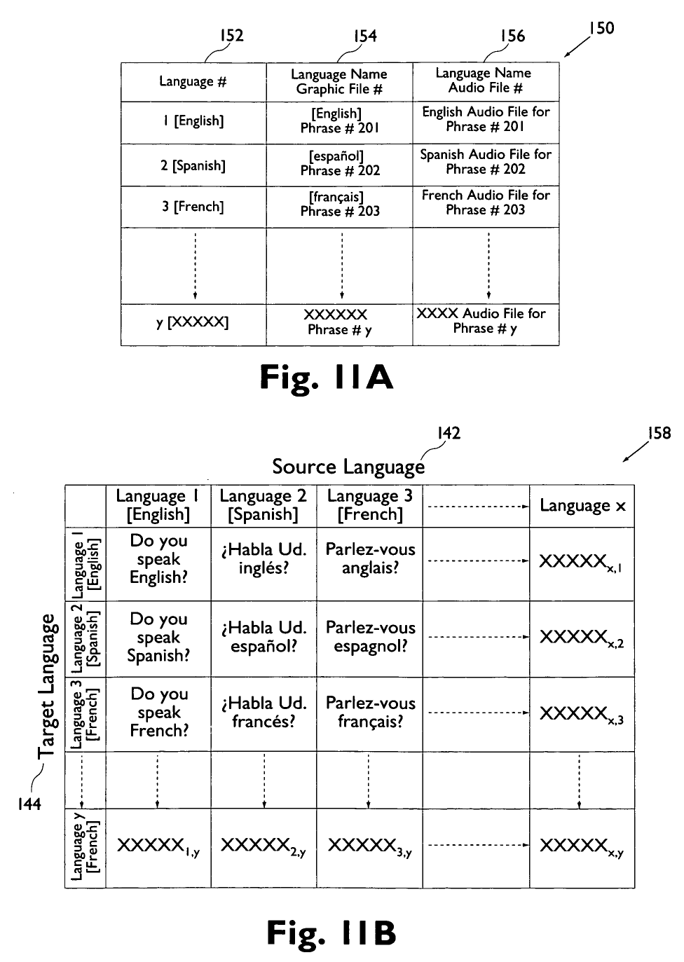

FIG. 10 is a table illustrating the database structure of the user preferences embodiment of the interlanguage communicator of FIG. 1.

FIG. 11A is a table illustrating the multimedia database structure of the language selection embodiment of the interlanguage communicator of FIG. 1.

FIG. 11B is a table illustrating the database structure of the language verification embodiment of the interlanguage communicator of FIG. 1.

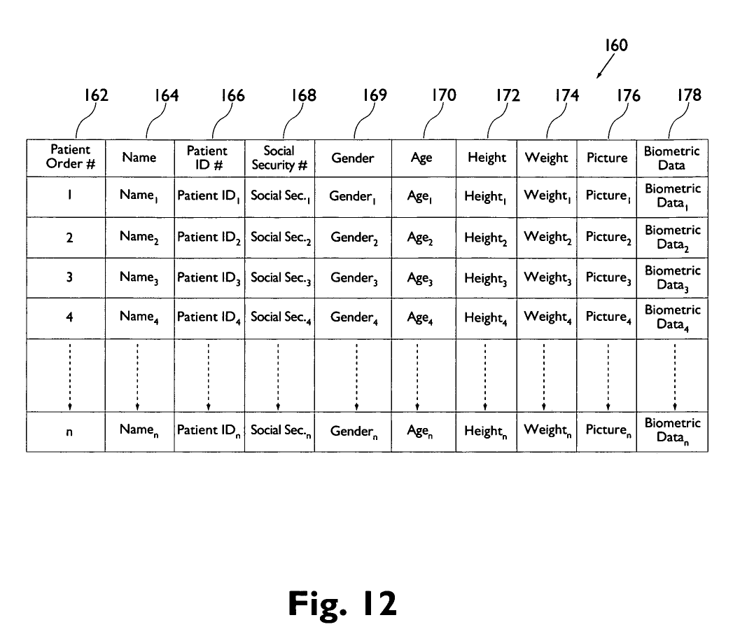

FIG. 12 is a table illustrating the database structure of the patient information embodiment of the interlanguage communicator of FIG. 1.

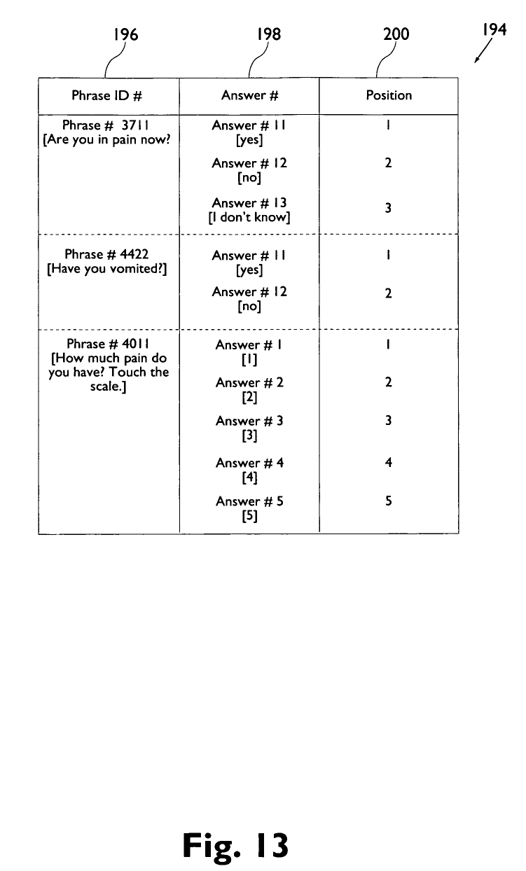

FIG. 13 is a table illustrating the database structure of the limited answer embodiment of the interlanguage communicator of FIG. 1.

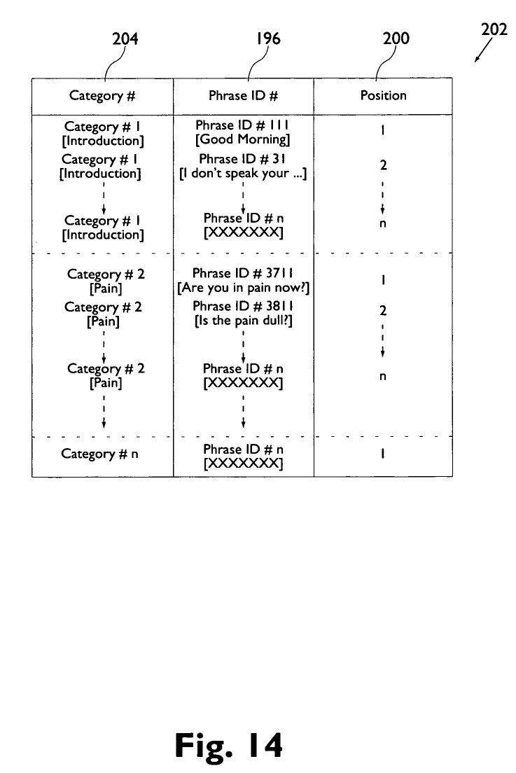

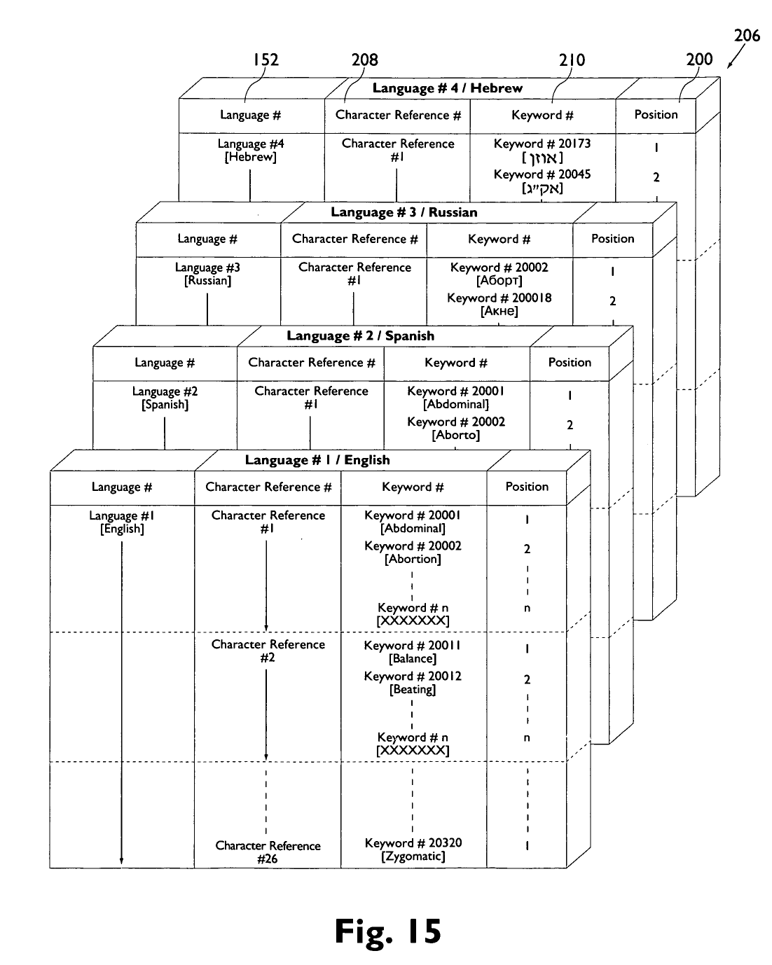

FIG. 14 is a table illustrating the database structure of the category assignment embodiment of the interlanguage communicator of FIG. 1.

FIG. 15 is an illustration of the three-dimensional, multilingual database structure of the keyword search embodiment of the interlanguage communicator of FIG. 1.

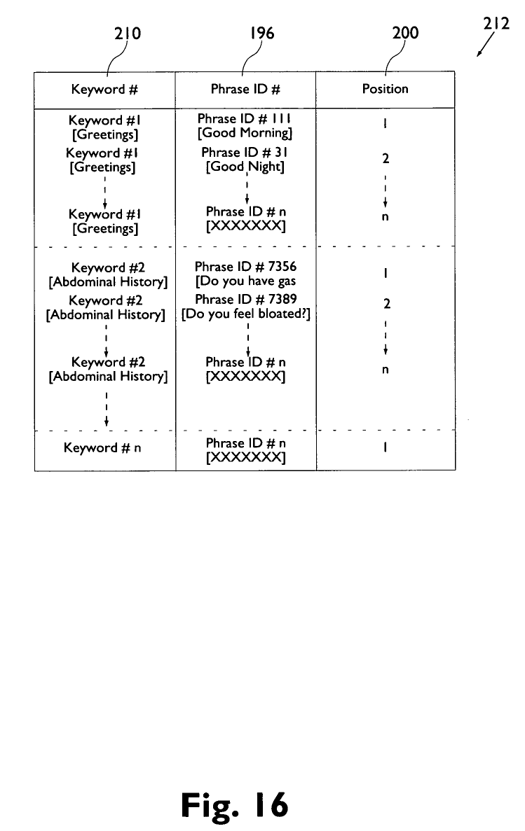

FIG. 16 is a table illustrating the database structure of the phrase search embodiment of the interlanguage communicator of FIG. 1.

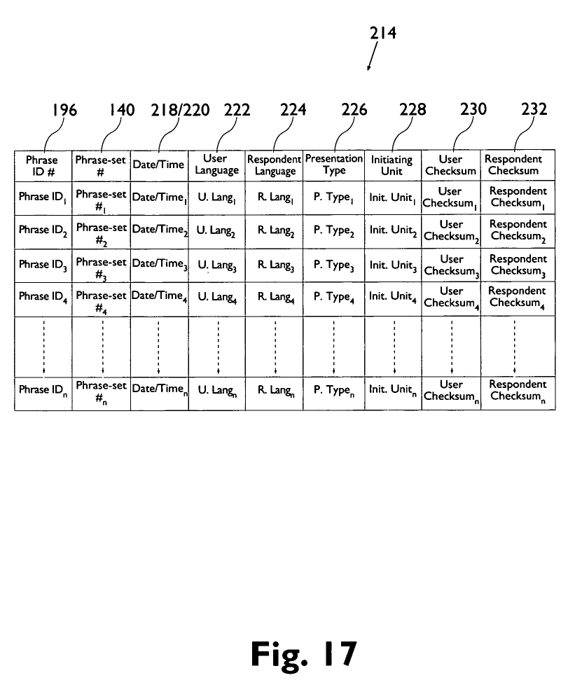

FIG. 17 is an illustration of the of the multimedia, interview history embodiment of the interlanguage communicator of FIG. 1.

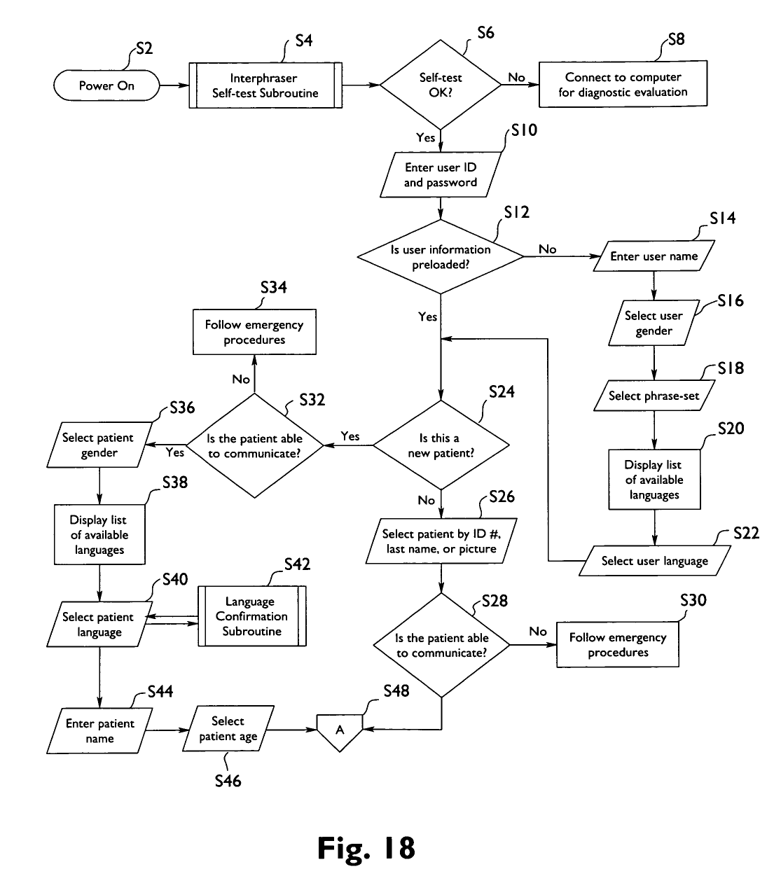

FIG. 18 is a flowchart illustrating the processing operation in accordance with the patient set-up embodiment of the interlanguage communicator of FIG. 1.

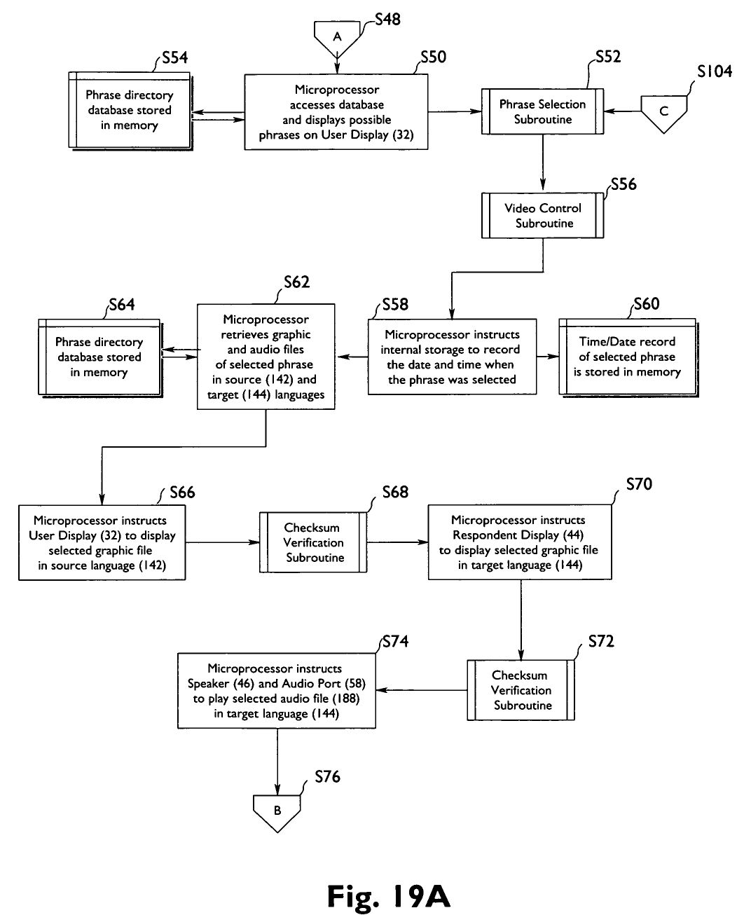

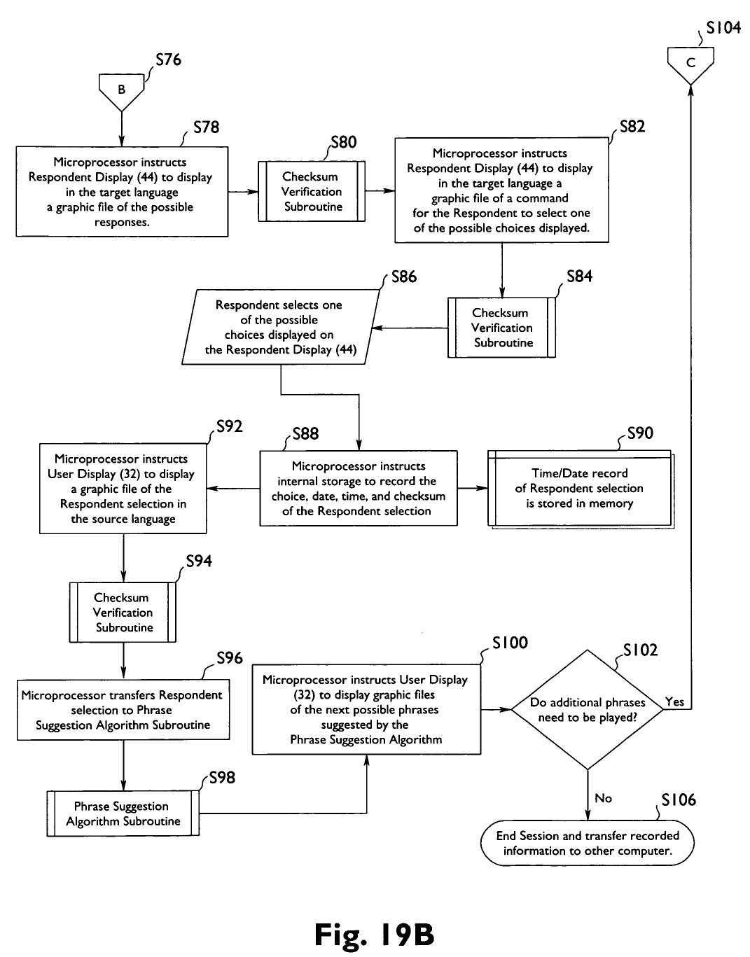

FIG. 19A is a flowchart illustrating the first section of the processing operation in accordance with the embodiment of the interlanguage communicator of FIG. 1.

FIG. 19B is a flowchart illustrating the second section of the processing operation in accordance with the embodiment of the interlanguage communicator of FIG. 1.

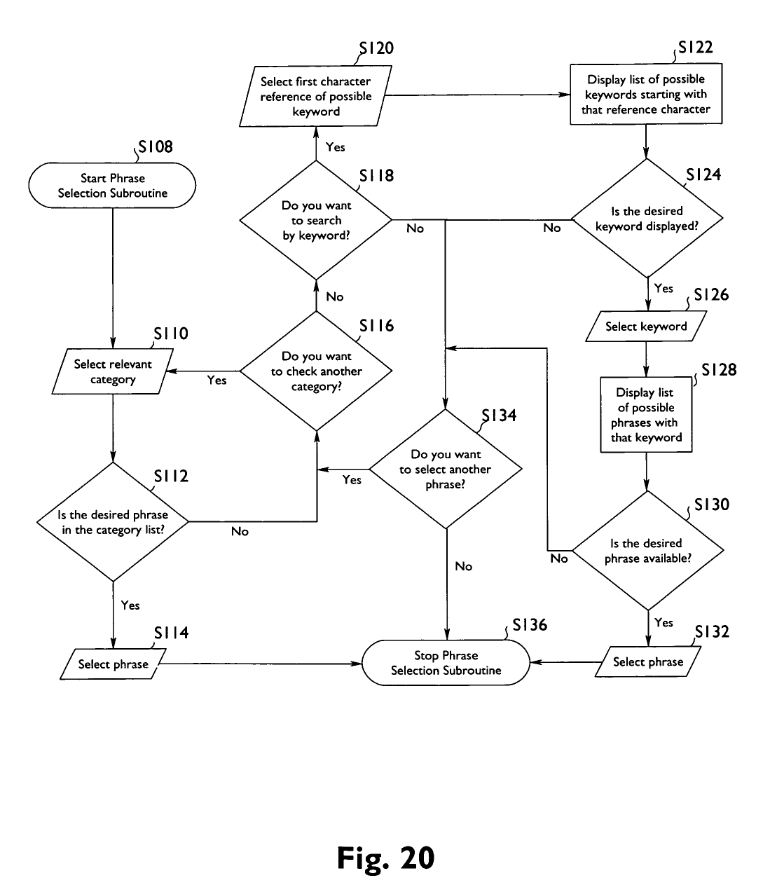

FIG. 20 is a flowchart illustrating the phrase selection subroutine embodiment of the interlanguage communicator of FIG. 1.

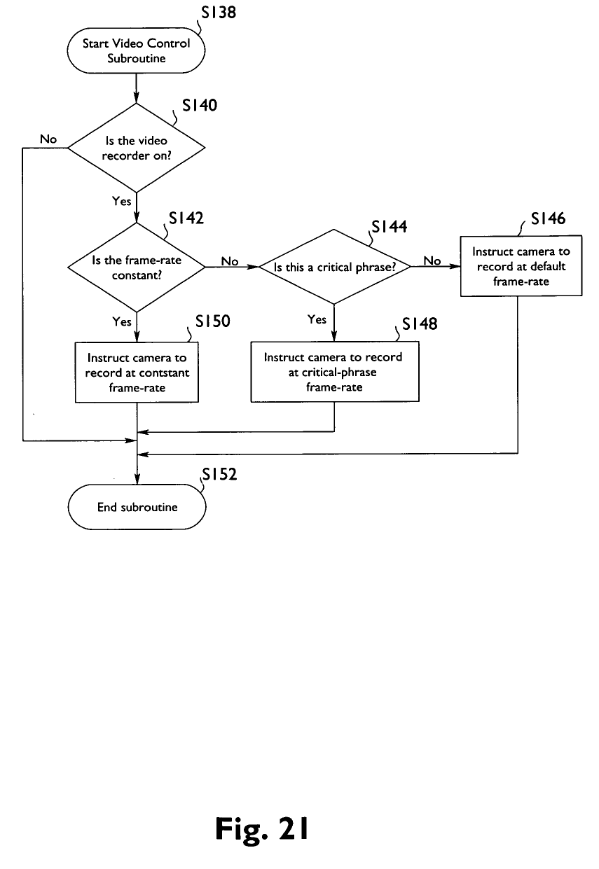

FIG. 21 is a flowchart illustrating the critical phrase video control subroutine embodiment of the interlanguage communicator of FIG. 1.

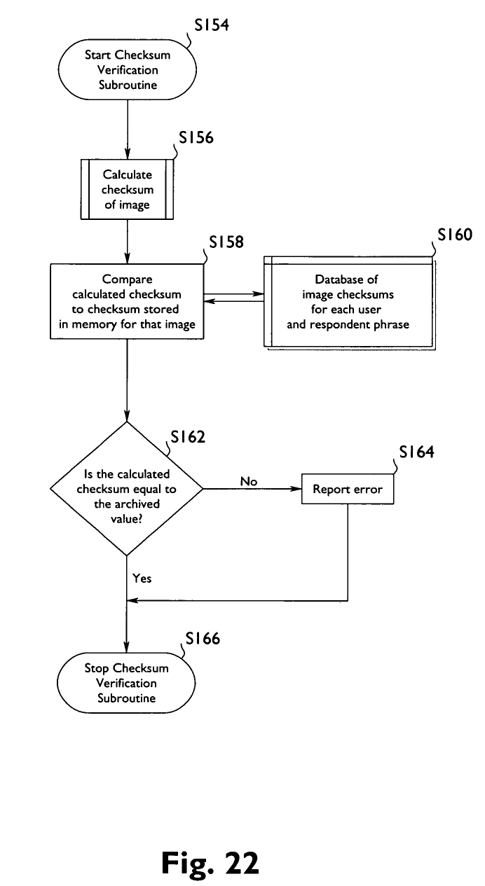

FIG. 22 is a flowchart illustrating the checksum verification subroutine embodiment of the interlanguage communicator of FIG. 1.

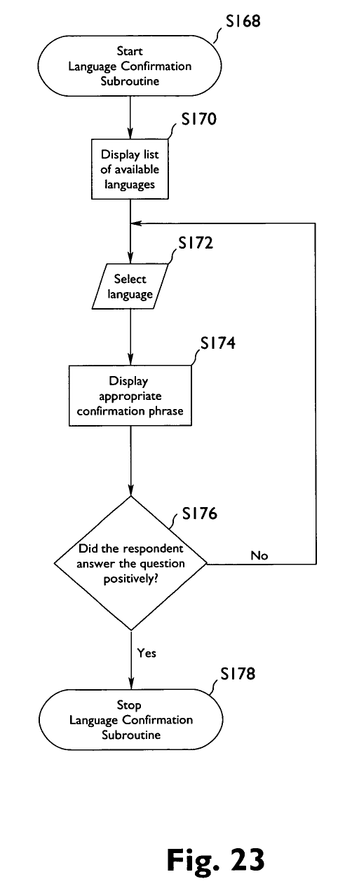

FIG. 23 is a flowchart illustrating the language confirmation subroutine embodiment of the interlanguage communicator of FIG. 1.

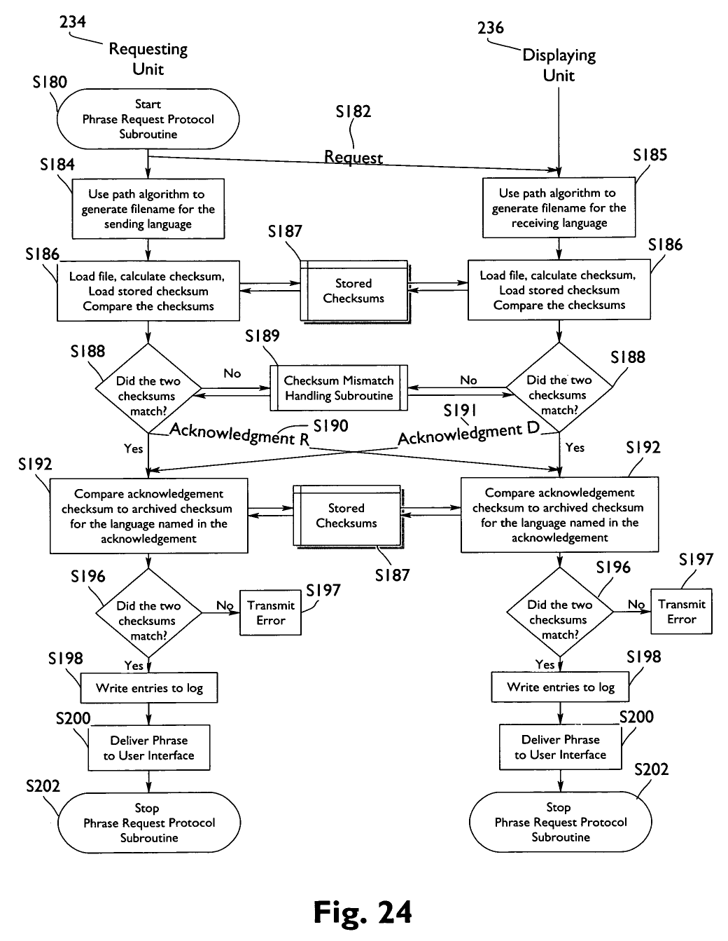

FIG. 24 is a flowchart illustrating the phrase request protocol subroutine embodiment of the interlanguage communicator of FIG. 7A.

FIG. 24 is a flowchart illustrating the checksum mismatch handling subroutine embodiment of the interlanguage communicator of FIG. 7A.

### DETAILED DESCRIPTION OF THE PREFERRED EMBODIMENTS

Referring now to FIG. 1 through FIG. 4A and FIG. 4B there are shown multiple views of the preferred embodiment of an interlanguage communicator which is an apparatus which has been developed to effect communication between different languages. Sets of phrases and accompanying audio files in a plurality of languages are stored in a non-volatile memory of the apparatus, and the apparatus is capable of displaying a designated phrase in a source language on a user side liquid crystal display screen with touch screen input 32 which is located on a user side 30. The apparatus is also capable of displaying a designated phrase in a target language on a respondent side liquid crystal display screen with touch screen input 44 which is located on a respondent side 42. In addition, voice in a designated target language can be outputted from speakers 46 or from an earphone jack 58. To attain these functions, the preferred embodiment of the invention is provided with an on/off switch 38 and selectable scroll wheels 34. Prior to operation the respondent side 42 is opened by pulling on an opening flange 54 and rotating to the desired angle around a respondent hub 56. Still further, a visual and audio record of the user/respondent interaction can be recorded with a camera system 52 and microphones 50. The respondent can be illuminated with lights 48. End cap 36 can be used to attach a lanyard or to provide a locking/unlocking cap to allow the respondent side 42 to be opened for access to the internal electronics. In addition a USB port 40 is included to allow uploading or downloading of files and to allow the transfer of the user/respondent history to a host computer. The internal batteries can be recharged via a USB port 40 or via a recharging jack 60.

FIG. 5 shows an alternative embodiment of the invention wherein the respondent side 42 can be detached from the respondent hub 56. Flange locking pin retractors 70 are pulled back thus retracting male flange locking pins 68 and thereby releasing a respondent flange 66. Electrical connections between the respondent unit 42 and the respondent hub 56 are via respondent-hub male connectors 62 and respondent-hub female connectors 64.

FIG. 6 shows another alternative embodiment of the detachable aspect of the invention wherein the respondent side 42 and the respondent hub 56 are detached as a unit by unlocking a retractable hub holder locking knob 74 thereby allowing a retractable respondent hub holder 72 to be slid to the side. A respondent hub wire and connector assembly 78 is disconnected from the user side wires and a user side wire and connector assembly 80 and respondent hub axles 76 are released from user side axle guides 79.

FIG. 7A shows an additional alternative embodiment of this invention comprising the use of two or more computing devices that communicate wirelessly with each other, each unit further comprising at least one relational database of phrases and associated information stored in non-volatile memory 88 together with executable software instructions configured to be accessed by a microprocessor 82 and to show selected phrases on a display 32 and/or to play selected phrases through a speaker 46. In this embodiment there are two units (A and B) that take the place of user side 30 and a respondent side 42 in the preferred embodiment of the invention. Alternative embodiments with more than two units are also possible.

FIG. 7B shows a holder 77 that can house two interlanguage communication units. Two units (e.g. 30 and 42) can be slid into the interior of the holder 77 along flanges 75. The two halves of the holder 77 can rotate relative to each other. The holder is preferably made of a clear material such as plastic, thereby allowing the user to view the user display 32 or the respondent display 44 while the units are within holder 77. If a user wishes they can slide the respondent side 42 unit B out and hand it to the respondent. When the user has finished the interaction, the units can be oriented in the holder 77 such that when the holder is closed the displays 32 and 44 are facing each other and are protected from damage. The holder 77 can be locked in a closed position by a latch (not shown) for transport or storage.

FIG. 8 is a schematic diagram of hardware illustrating a circuit configuration in such a interlanguage communicator. In FIG. 8, the respondent side 42 has a microprocessor 82 for accomplishing a central role in various control functions. The microprocessor 82 has volatile memory 86 for the temporary storage of data and/or programs and non-volatile memory 88 for the long-term storage of phrases and control programs (which will be described later). In addition, the microprocessor 82 is connected via a system bus (not shown) to the input/output hardware: user side liquid crystal display screen with touch screen input 32 and respondent side liquid crystal display screen with touch screen input 44, microphones 50, speakers 46, camera system 52, barcode reader 90, radiofrequency identification (RFID) tag reader 92, and biometric data reader 94. Communication between the user side 30 and the respondent side 42 is controlled and aided by a board-to-board interface 96. Power usage and battery charging is controlled by the power management unit 98. Communication between the interlanguage communicator described in this invention with a host computer system 99, similar units, or network can be implemented via USB 84 or via a wireless interface system 100 such as 802.11 or Bluetooth®. Note that communication from board to board can be via the wireless interface system 100.

A possible user screen layout is shown FIG. 9A. A past phrases section 102 shows a list of the commands made, questions asked, and the answer provided. Scroll bar 104 can be used to scroll through the past phrases. An alternative embodiment (not shown) might also show the date and time that the phrase was selected and played. Please note that the exemplary illustration does not show any command-type phrases; however, in the preferred embodiment questions, informational statements, or commands might also be played.

A possible phrases section 106 shows possible phrases that the control system displays. Scroll bar 108 can be used to scroll through the possible phrases. In alternative embodiments the phrases suggested can be in a standard fixed order, an order preferred by the user, an order based on past usage by the user, or based on an analysis of the direction of the interview. By example, when a physician conducts a structured interview and a patient reports a pain in his knee, the physician will not spend a great deal of time asking questions about the patient's abdominal system.

In a preferred embodiment the user will also be able to display phrases by thematic category by selecting one of the categories shown in a category section 110. In addition, the user can search for a particular phrase by keyword 112 in an index search section 114. For any source language a set of character references (alphabetic, phonetic representations, or symbols) can be displayed and selected. The keywords 112 associated with a particular character reference will display. When the user selects a particular keyword 112 a list of possible phrases will display in the possible phrases section 106.

A current phrase section 115 shows a source language phrase 116, a target language phrase 118, and user-controlled possible response buttons 119. When a phrase is selected the list of possible answers (if appropriate) is shown on the respondent screen 44 and on the user screen 32 as the list of user-controlled possible response buttons 119. When the respondent selects the appropriate possible answer on the respondent screen 44, the answer chosen will also flash on the user-controlled possible response buttons 119. The user can also respond for the respondent by selecting one of the user-controlled possible response buttons 119 in case the respondent is unable to respond. The user/respondent history retains a record of whether the response is made on the user screen 32 or on the respondent display 44. In the preferred embodiment a video record from the camera system 52 will further document who has responded.

FIG. 9B shows the preferred layout of the respondent screen 44 with a sample phrase in Russian with the appropriate translation added. Thus, the current verified phrase, “Do you have palpitations?” on the user screen 32 is also verified by checksum comparison and displayed on the respondent screen 44 in Russian, the target language 124. An instruction to the respondent informing them to “Touch the correct answer” 128 is also verified and displayed on the respondent screen 44 in the target language 144. Possible respondent-answer buttons 126 to the phrase selected by the user are verified and displayed on the respondent screen 44 in the target language 144. One of the possible respondent-answer buttons 126 can then be selected by the respondent as a way to inform the user of the respondent's answer. Positive audio feedback to the respondent that the correct answer was selected can also be provided by playing the associated audio file with the same phrase identification number 196 in the target language 144 through a speaker 46.

FIG. 10 is an illustration showing a user preference table 130. In the process of using the interlanguage communicator described in this invention a number of different settings can be made for each user. Each user is assigned a user number 132. Each user can enter a user name 134 and password 136 that is securely hashed by one of the well-known algorithms, such as MD5. A user's gender 138 can be set; this is important depending on the language. By example a female Spanish-speaking firefighter might say, “Soy la bombera.” On the other hand a male Spanish-speaking firefighter would say, “Soy el bombero.” An alternative embodiment that is not shown would reflect the user's status. In some languages there are varying levels of formality that are reflected in the grammar, spelling, and other factors.

In a preferred embodiment there will be multiple phrase-sets loaded in this device at the same time. By example a border patrol agent might use a special phrase-set for border patrol but may need to switch immediately to a medical phrase-set if they discover a badly dehydrated Cantonese-speaker who has been trapped inside of a cargo container for several days without water. Each phrase-set 140 would have a unique number. A particular phrase-set could be set as the default selection. Similarly if an English-speaking person is going to go a French-speaking country, it would make sense to set a default source language 142 and default target language 144 to English and French, respectively. Date/time format 146 can also be preset in the preferred embodiment. A user in the United States may wish to have the dates recorded in the month/day/year format but have the time recorded in an a.m./p.m. format. In Europe, on the other hand the user might wish to have the dates shown as day/month/year and the time in a 24-hour format.

Audio/video settings 148 include the desired sampling rate, frame-rate, and other measures well known in the industry. In addition, there could also be settings (not shown) regarding which phrase identification number numbers are considered critical and what the critical phrase frame-rate should be set at if the rate is, indeed, variable.

FIG. 11A is the diagram of a preferred embodiment of the language selection table 150. Each language available is assigned a language number 152 which corresponds to a language name which is represented by a language name graphic file 154 and an audio file of a native speaker pronouncing the language name in that language. The combination of a language name graphic file 154 for visual recognition and a language name audio file 156 for audio recognition will enable the user and/or respondent to select the source and target languages respectively.

FIG. 11B is the diagram of a possible embodiment of the language confirmation table 158. With the language confirmation-subroutine (described later) the user is able to confirm that the language chosen by or for the respondent is correct. By using the language confirmation table 158, the user can confirm the target language 144 choice and minimize and catch any selection errors. Every cell in the table maps to a combination of the source language 142 and target language 144. Each cell represents both a PNG format graphic of the confirming phrase that can be displayed on the respondent screen 44 (e.g. “Parlez-vous anglais?”) and the audio file of the same phrase that can be played. On the respondent screen 44 will also be displayed the possible answers as PNG graphics (“yes” and “no”) in the appropriate target language 144.

FIG. 12 shows a patient information table 160 which includes a patient order number 162, patient identification number 166, social security number 168, age 170, height 172, weight 174, picture 176, and any biometric data 178 that is available. It is clear that any of the items in the patient information table 160 may take different forms in different locale and/or embodiments. For example the weight 174 and height 172 can be in pounds and feet or in kilograms and meters. The social security number 168 will be a different number in different places. Similarly the biometric data 178 that will be available could be a range of data including fingerprints, retinal scan, voice print, or DNA scan. In different embodiments the information in the patient information table 160 might be entered directly via a virtual keyboard, a keyboard attached via the USB 40, via barcode reader 90, via RFID tag reader 92, host computer 99 or via wireless interface system 100 to a local area network.

FIG. 13 is a limited answer table 194. It shows for every phrase number 196, possible limited answers 198 and their relative position 200 to the other answers. Note that while answers are phrases also and have their own phrase identification number 196, they can also be identified by their answer number 198.

FIG. 14 is a category assignment table. For each category number 204 there are assigned a number of phrases 196 in a position 200 relative to each other. When the user selects a category (e.g. “Pain” in the medical phrase-set) a list of phrases 196 that relate to pain are displayed in the possible phrases section 106. Note that while categories 204 are phrases also and have their own phrase identification number 196, they can also be identified by their category number 204.

FIG. 15 is a three-dimensional, multilingual database structure of the keyword search table 206. For each language 152 there is a collection of character references 208 which are associated with keywords 210. The keywords are displayed in position 200 relative to each other. The character references 208 may refer to a series of letters, phonetic sounds, symbols, or sets of symbols. Note that while character references 208 are phrases also and have their own phrase identification number 196, they can also be identified by their character reference number 208.

FIG. 16 is a phrase search table 212 that associates the keywords 210 to phrases 196. The phrases are listed in relative position 200. Note that while keywords 210 are phrases also and have their own phrase identification number 196, they can also be identified by their keyword number 210.

FIG. 17 is a user/respondent history table 214. There is a range of different items that are associated and saved for every phrase 196 selected by the user and then answered by the respondent. In the preferred embodiment there is a table that is created (with its own unique internal numeric ID) for each interview with each record comprising the date 218 and time 220 that the interview began, the ID of the interviewer (not shown), and the ID of the respondent (not shown). In the preferred embodiment the log of the interview will include one row for every phrase ID 196 that is displayed on a screen 32 or 44 or played through a speaker 46. Each row will include the user language 222, the respondent language 224, the phrase-set # 140 (in case the phrase-set 140 is changed during the interview, an identifier as to the presentation type 226, the initiating unit that started the action 228, the user unit checksum 230 for that presentation, and the respondent unit checksum 232 for that presentation. Additional records that are not shown can also be included, such as an audio record, 234, a video record 236, and other means for multimedia interaction that are known in the industry. At the conclusion of user/respondent interaction, the user/respondent history table 214 can be uploaded to another computer or computers when transferring the patient, for training, for case review, or for legal purposes.

FIG. 18 is a flowchart illustrating the processing operation in accordance with the patient set-up procedure in a preferred embodiment of this invention. Upon power on in step S2, a self-test subroutine S4, as is well-known in the art, is called. In step S6 a decision is made regarding the whether the system is working correctly or not. If the self-test S4 is not passed, in step S8 the interlanguage communicator is connected to a host computer for additional diagnostic evaluation. Otherwise, the initial set-up continues in step S10 by entering the user identification number and password.

In step S12 the system tests whether the user information is preloaded. If it is, then the program continues to load patient information in step S24. If the user information has not been preloaded, then the program progresses from step S12 to step S14 to begin loading the user name 134. Step S16 loads the user gender 138 and step S18 selects a default phrase-set 140. In step S20 a list of available languages from the language selection table 150 is displayed thus allowing the user to select a default user language S22 from the list of available languages 150. Note that step S22 loads into memory what will be the source language 142.

In the decision step S24 the system tests whether the information about the patient has been preloaded. In the preferred embodiment, if this is a patient whose information has been preloaded, in step S26 the user can select the patient by last name, picture, or by identification number. Operation then proceeds to the decision in step S28 regarding whether the patient can communicate. Inherent in that decision is also whether or not the patient has the necessary level of awareness to be cognizant. If the answer to step S28 shows that the patient cannot communicate and/or is not cognizant then the professional must follow the regulated emergency procedures in their field and/or area (step S30).

The system can then proceed to display possible phrases that can be played in step S50. Note that step S48 is the connector between FIG. 18 and FIG. 19A.

If, on the other hand, this is a new patient, or one whose information is not available in the system, then the system can proceed from step S24 to step S32 regarding whether the patient can communicate. Inherent in that decision is also whether or not the patient has the necessary level of awareness to be cognizant. If the answer to step S32 shows that the patient cannot communicate and/or is not cognizant then the professional must follow the regulated emergency procedures in their field and/or area (step S34).

If step S32 shows the patient can communicate adequately, then the system progresses in step S36 to loading information about the patient gender 169. In step S38 a list of available languages from the language selection table 150 is displayed thus allowing the user to select the patient language S40 from the list of available languages 150. Note that step S40 loads into memory what will be the target language 144. Step S42 allows the confirmation of patient language choice in step S40 with the language confirmation subroutine S42. Patient data entry continues in step S44 with the patient name 164. Step S46 allows entry of the patient age 170.

The system can then proceed to display possible phrases that can be played in step 266. Note that step 264 is the connector between FIG. 18 and FIG. 19A.

FIG. 19A is a flowchart illustrating the first section of the processing operation in accordance with the preferred embodiment of this invention. After progressing from the connector at step S48, the system can proceed to display possible phrases that can be played in step S50 by accessing the phrase directory database 180 in step S54. A phrase selection subroutine is called in step S52 which will enable the user to determine which phrase 196 will be played. Once a phrase 196 has been selected, a video control subroutine is called in step S56 to determine if this is a critical phrase and if the video recording frame rate should be adjusted (shown later).

In step S58 the microprocessor 82 instructs the storage (step S60) in non-volatile memory 88 of the date and time that phrase 196 was selected. In step S62 the phrase directory database 180 is accessed to retrieve a PNG user screen graphic file 186 and an audio file 188 in the source language 142 and target language 144 for the selected phrase 196. In step S66 the user display 32 is instructed to display the PNG user screen graphic file 186 in the source language 142 on the user side liquid crystal display 32.

To verify that the correct graphic was loaded and that it displayed correctly, in step S68 the checksum verification subroutine is called (described later). Then in step S70, the microprocessor 82 displays the PNG respondent screen graphic file 184 in the target language 144 on the respondent side liquid crystal display screen 44. To verify that the correct respondent screen graphic 184 was loaded and that it displayed correctly, the checksum verification subroutine is called again in step S72.

To enhance understanding by the patient, in step S74 the microprocessor 82 instructs the speakers 46 and audio port 58 to play the previously selected audio file 188 in the target language 144. At this point, therefore, the patient has seen the respondent screen graphic file 184 on the respondent side liquid crystal display screen 44 and has also heard the accompanying audio file 188 spoken.

In step S78 the microprocessor 82 instructs the respondent side liquid crystal display screen 44 to display a PNG respondent screen graphic file 184 in the target language 144 of possible answers 198 that are appropriate for the selected phrase 196. Note that the step S76 is the outbound connector “B” between FIG. 19A and FIG. 19B. To verify that the correct graphic was loaded and that it displayed correctly, in step S80 the checksum verification subroutine is called (described later). On the respondent side liquid crystal display screen 44 there is also shown a command in step S82 in the form of a PNG respondent screen graphic file 184 in the target language 144 that instructs the patient to select the one of the possible answers 198 that are displayed. Again, in order to verify that the correct graphic was loaded and that it displayed correctly, in step S84 the checksum verification subroutine is called (described later).

When, in step S86 the patient selects one of the possible answers 198 by touching the respondent side liquid crystal display screen with touch screen input 44. In step S88 the microprocessor 82 instructs the non-volatile memory 88 in step S90 to record the phrase 196 that was played, the answer selected 198, the phrase-set 140, the date 218, the time 220, the audio record 224, the video record 226, and the accompanying checksum.

To enable the user to understand the patient's answer 198, the microprocessor 82 in step S92 instructs the user side liquid crystal display screen 32 to display a PNG user screen graphic file 184 in the source language 144 of the answer 198 selected by the patient. To verify that the correct graphic was loaded and that it displayed correctly, in step S94 the checksum verification subroutine is called (described later).

The microprocessor 82 then in step S96 transfers the patient answer 198 selection to the phrase suggestion algorithm which in step S98 suggests a list of the next possible phrases to display. The suggested phrases from step S98 are then displayed in step S100 when the microprocessor 82 accesses the phrase directory database 180 (not shown), retrieves the suggested PNG user screen graphic files 186 in the source language 142, and then displays them on the user side liquid crystal display 32.

In step S102, the user is given the opportunity to decide if additional phrases need to be played. If the answer is positive, then the program returns in step S104 to the outbound connector “C” on FIG. 19A. If the answer is negative, then the session is ended and recorded information is transferred to a host computer system 99, similar units, or network via USB 84 or via a wireless interface system 100 such as 802.11 or Bluetooth®.

In FIG. 20 the phrase selection subroutine is started step 108. In step 110 the user is given the opportunity to choose which category 204 the relevant phrase 196 is likely to be. The category 204 possibilities are displayed when the microprocessor 82 accesses the phrase directory database 180 (not shown), retrieves the suggested PNG user screen graphic files 186 in the source language 142, and then displays them on the user side liquid crystal display 32 in section 110. Thus by example, in the preferred embodiment of a medical phrase-set the PNG user screen graphic files 184 representing the category 204 of “Pain” or “Chest Problems” would be displayed.

The presence or absence of the correct phrase 196 in that category 204 is tested in step 112. The user can then either select a phrase that is displayed in step S114 or can check in step S116 for other categories 204. The user can also search by keyword 210 in step S118 by selecting a character reference 208 in step S1120 as a means of displaying a list of keywords in step S122. If the correct keyword 210 is displayed in section 112 on the user side liquid crystal display 32 in step S1124, then it can be selected in step S126. The selection of a keyword 210 will generate in step S128 a list of possible phrases in section 106 on the user side liquid crystal display 32. If the desired phrase is displayed in step S1130, the user can select the phrase in step S132 and exit the phrase selection subroutine in step S136. If, on the other hand the desired phrase 196 is not shown, then in step S134, the user can decide whether to find another phrase 196 or exit the phrase selection subroutine in step S136.

FIG. 21 shows the video control subroutine. When called in step S138, the first question that is answered in step S140 is whether the camera system 52 is on. If the camera system 52 is off, then control is transferred step S1152 and the termination of the video control subroutine. If the camera system 52 is on, then the next question in step S142 is whether or not the frame-rate is set to be constant or not. If the frame-rate is set to be a constant rate, then in step S1150 the camera system 52 is instructed to record at a constant rate.

If, on the other hand, the frame-rate can be variable, then in step S144 the question is asked regarding whether the phrase 196 that is selected is a critical phrase. If the answer is negative, then in step S146 the camera system 52 is instructed to record at the default frame-rate and then proceed to step S152 to terminate the video control subroutine. If the phrase is designate as a critical phrase by the user, then in step S148, the camera system 52 is instructed to record at the preset critical-phrase frame-rate and to then proceed to step 152 and the termination of the video control subroutine.

Step S154 in FIG. 22 starts the checksum verification subroutine. Step S156 calls a subroutine to calculate a checksum of the displayed image. To those knowledgeable in the art, there are many techniques and algorithms that are well-known and readily available. In the preferred embodiment, the MD5 checksum algorithm will be used. In alternative embodiments, the SHA-type checksums might also be implemented.

In step S158, the calculated checksum from step S156 is compared to the checksum for that phrase 196 that is retrieved in step S160 from the non-volatile memory 88. In step S162 it is decided whether the two checksums are the same. If the two checksum are not equal, it indicates that there has been an error that is reported in step S164. If the checksums are indeed equal, then the checksum verification subroutine is terminated at step S166.

Step S168 in FIG. 23 starts the language confirmation subroutine by displaying in step S170 the list of available languages from table 150. When the user selects the language in step 172 an appropriate confirmation phrase 196 from the language confirmation table 158 is displayed and the accompanying audio file 188 is played. The patient is instructed to answer positively or negatively to whether or not they speak that language in step S176. If the answer is negative the program loops back to pick another language in step S170. If the answer is positive, then the language confirmation subroutine is terminated at step S178.

FIG. 24 shows the Phrase Request Protocol Subroutine S180 when there are two independent units communicating wirelessly such as in FIG. 7. The requesting unit 234 sends a request S182 to the displaying unit 236. The request S182 includes at least the following pieces of data: an identifier for the requesting unit 234 (e.g. a serial number), the phrase identification number 196, and a presentation type 226. At essentially the same time both units proceed in parallel.

The requesting unit 234 uses the path algorithm S184 to generate a filename for the phrase requested in the language (source language 142) of the requesting unit 234. At essentially the same time the displaying unit 236 uses the path algorithm S236 to generate a filename for the phrase requested in the language (target language 142) of the displaying unit 234. Using the filenames generated independently by the path algorithm S236 each unit loads the file, calculates the checksum of the file, and then compares the calculated checksum against a checksum for that file that was previously calculated and saved in a stored checksum database S187. If the checksum comparison S188 on the requesting unit 234 gives a true result then an acknowledgment R S190 is sent to the displaying unit 236. Similarly if the checksum comparison S188 on the displaying unit 236 gives a true result then an acknowledgment D S191 is sent to the requesting unit 234. If when either finds that the result of the checksum comparison S188 is false, then the information is sent to the checksum mismatch handling subroutine S189.

The acknowledgement message R S190 includes at least the following pieces of data: an identifier of the requesting unit 234, the phrase identification number 196, the presentation type 226, the currently selected language of the unit 222 (also source language 142), and the calculated checksum of the file being presented on that unit. The acknowledgement message D S191 includes at least the following pieces of data: an identifier of the displaying unit 236, the phrase identification number 196, the presentation type 226, the currently selected language of the unit 224 (also target language 144), and the calculated checksum of the file being presented on that unit. Upon receiving the acknowledgment from the other unit each then compares the checksum included in the acknowledgment message S190 or S191 to the archived checksum for the language named in the acknowledgment by accessing the stored checksum database S187.

The comparison is tested in each unit in step S196. If the result is true then entries are made to a log S198, the phrase is delivered to the user interface S200 and the phrase request protocol subroutine is exited S202. The log entries S198 in the preferred embodiment comprise the date and time, the identifiers of that unit, the phrase identification number 196, the presentation type 226, and the calculated checksum for the file as presented on the displaying unit. This is sufficient information to replay the interview and to ensure that the replay is done with the same data files as the original interview. Note that each request will include at least two entries—one for each display on each unit. If the result is false, on the other hand, then an error is transmitted S197 and in the preferable embodiment the program would be halted.

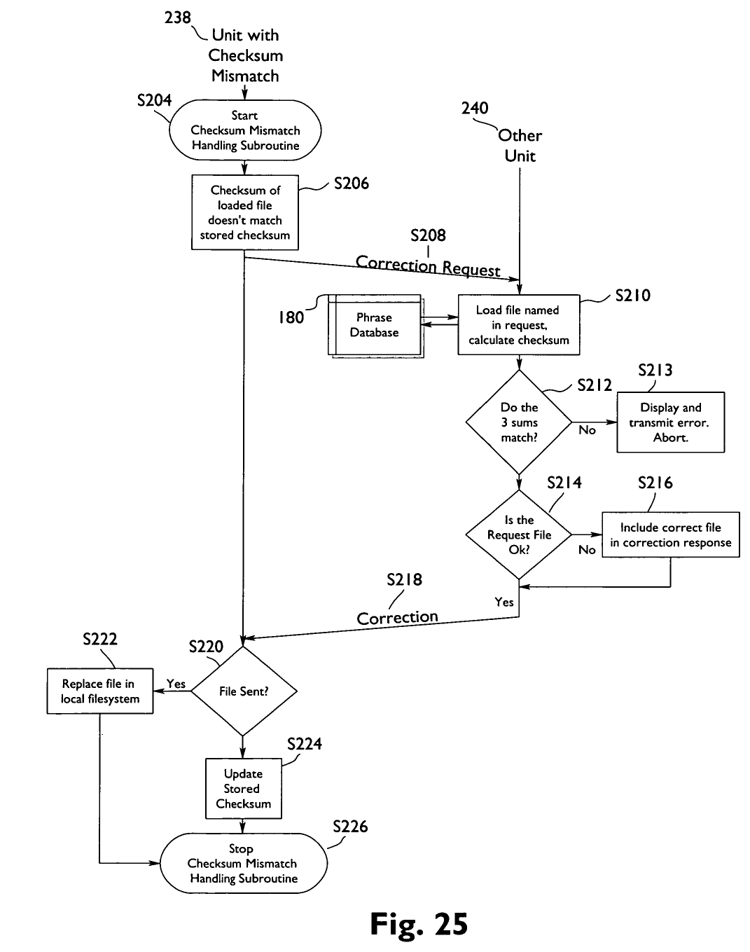

The checksum mismatch handling subroutine S204 for a two or more unit system is shown in FIG. 25. Transfer to the checksum mismatch handling subroutine occurs when a mismatch is found in step S188 on FIG. 24. A correction request S208 is sent to the other unit 240. The correction request S208 includes at least the following pieces of data: an identifier of the unit that detected the error, the checksum of the file as loaded, the verifying checksum from the checksum database S187 that it was compared against, and sufficient data to identify the file in question further comprising at least one of: a complete filename, a phrase identification number 196, the language of that unit, and the presentation type 226. Note that both units have a checksum mismatch handling subroutine S189 and the same relational phrase database 180 and can, therefore, troubleshoot and correct errors in the other unit called 240 as an expedience. One knowledgeable in the art will recognize that the other unit 240 could be either the requesting unit 234, the displaying unit 236, or a plurality of other additional units not described in this embodiment.

The information in the correction request S208 is used to load the appropriate file from the phrase database 180 and calculate a new checksum S210. At this point there are four checksums available (two from each unit), if three of the four checksums match S212, the program is transferred to test S214 if the file that generated the original request S182 is okay. If the result of test S212 is negative, then a error is displayed, transmitted, and recorded S213. If test S214 is true, then the correction message S218 is sent. If test S214 is false, then the correct file is included S216 in the correction message S218 prior to sending. The correction message S218 includes at least the following pieces of data: an identifier for the unit providing the correction, an identifier for the unit being corrected, the correct checksum for the file, and the complete contents of the file, if necessary.

The checksum mismatch handling subroutine S189 then checks S220 to see the nature of the correction. If a file was sent, it is replaced in the local file system S222, while if only a checksum is sent, then the checksum is updated S224. The checksum mismatch handling subroutine S189 then returns to S188 on FIG. 24 for a retest of the checksum.

Note that in this embodiment, error correction requires that three of the four checksums participating in the comparison are in agreement, indicating that the fourth checksum is in error and may be safely corrected. If fewer than three checksums match, the error is considered uncorrectable. An embodiment may present a fatal error and therefore refuse to allow the phrase to be presented, or may allow the phrase to be presented as-is and present a warning about the failure in data integrity. Note that if more than two units are participating in the conversation, the unit with the erroneous checksum may send additional correction requests to other units to attempt to reconcile its database.

Note further that transmission errors can also occur between the units; therefore, in the preferred embodiment each unit also confirms that the file received matches the checksum received. If the file does not match, this indicates a failed transmission and another correction request needs to be sent.

The present invention is directed to a system for communication between two or more people that do not speak the same language and more particularly to an interlanguage communication apparatus and method that enables a self-reinforcing, self-validating, and self-repairing ability to communicate information between humans.

An apparatus, method, and control means in accordance with the invention permit a user to easily communicate between two or more persons via a 2-way audiovisual presentation that can be verified for accuracy. The apparatus includes two or more displays (screens) that can be moved and/or rotated relative to each other, sound generators (e.g. loudspeakers), and the control equipment necessary to present the audiovisual material on the displays and/or sound generators.

Thus, a user that speaks a particular source language can choose a particular phrase (e.g. “Are you in pain?”) from many possible phrases, can present an audiovisual presentation of the translation of that phrase to a respondent that speaks a particular target language, and can then have the respondent select a particular answer in the target language which is then translated back into the source language and presented in an audiovisual manner to the user.

Note that while this invention is directed to communicating between languages, in alternative embodiment it could also apply to situations where the people involved speak the same or similar language. For example, an English-speaking helicopter paramedic could communicate with an English-speaking patient despite the very loud environment that makes verbal communication or speech recognition very difficult.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. In the following description, numerous specific details are provided, such as examples of programming, user selections, network transactions, database queries, database structures, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

### SEQUENCE LISTING

Not Applicable

I claim:

1. An interlanguage communication tool comprising:
(a) a computing system further comprising:
(1) a processor for processing software instructions and data;
(2) a machine-readable storage medium storing executable code for use by the processor;
(3) a display interfaced to the processor;
(4) a speaker interfaced to the processor;
(5) an input device interfaced to the processor for receiving input choices;
(b) an instruction set for selecting a first language and at least one additional language from a plurality of languages;
(c) a database stored in the machine-readable storage medium containing at least one phrase each in at least one language, wherein each of the phrases is stored as a graphic image file having an associated checksum, and further containing an audio file recording and associated checksum for each phrase in each language of a native speaker saying the phrase in their language;
(d) a software instruction set configured to cause the computing system to perform the following steps:
(1) loading the graphic image file representation of a phrase selected in the first language;
(2) comparing the first checksum of the first language graphic image file selected to the second checksum of the graphic image file that actually loaded for display by the computing system;
(3) signaling a checksum mismatch if the first checksum of the first language graphic image file selected doesn't match the second checksum of the graphic image file that actually loaded; and
(4) displaying the first language graphic image file when the first checksum matches the second checksum;
(e) a software instruction set configured to cause the computing system to perform the following steps:
(1) loading the graphic image file of the additional language equivalent phrase;
(2) comparing the third checksum of the graphic image file of the additional language equivalent phrase selected to the fourth checksum of the graphic image file that actually loaded;
(3) signaling a checksum mismatch if the third checksum of the at least one additional language equivalent graphic image file of the phrase selected doesn't match the fourth checksum of the graphic image file that actually loaded for display by the computing system; and
(4) displaying the at least one additional language graphic image file on the display when the third checksum matches the fourth checksum;
(f) a software instruction set configured to cause the computing system to perform the following steps:
(1) loading the audio file representation of the at least one additional language of the phrase selected in the first language;
(2) comparing the fifth checksum of the at least one additional language equivalent audio file of the phrase selected to the sixth checksum of the audio file that actually loaded;
(3) signaling a checksum mismatch if the fifth checksum of the at least one additional language equivalent audio file of the phrase selected doesn't match the sixth checksum of the audio file that actually loaded for play by the computing system; and
(4) playing the at least one additional language audio file through the speaker when the fifth checksum matches the sixth checksum.

2. The interlanguage communication tool as in claim 1, further comprising a list of possible answers to phrases posed as questions that can be displayed on the at least one display.

3. The interlanguage communication tool as in claim 2, wherein a selection from the list of possible answers can be made.

4. The interlanguage communication tool as in claim 3, wherein the selection from the list of possible answers can be shown on the at least one display in a plurality of languages.

5. The interlanguage communication tool as in claim 1, further comprising multiple detachable displays that can be moved or rotated relative to each other.

6. The interlanguage communication tool as in claim 1, further comprising a camera system and software instructions configured to provide video recording of an interlanguage communication interview.

7. The interlanguage communication tool as in claim 1, further comprising a microphone system and software instructions configured to provide audio recording of an interlanguage communication interview.

8. The interlanguage communication tool as in claim 1, further comprising a history of phrases posed as questions, phrases posed as answers that were selected to the questions, wherein the phrases are date and time-stamped with an accompanying audio and video record, wherein the history can be searched and wherein the history can be uploaded.

9. Claim 8, wherein the history can be uploaded to a host computer.
